(19) United States
(12) Patent Application Publication
(10) Pub. No.: US 2003/0202099 A1
(43) Pub. Date: Oct. 30, 2003

(54) Security camera system

(76) Inventors: Taku Nakamura, Yokohama (JP); Keisuke Inata, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/420,842

(22) Filed: Apr. 23, 2003

(30) Foreign Application Priority Data
Apr. 25, 2002 (JP) 2002-123393

(51) Int. Cl. H04N 7/18

(52) U.S. Cl. 348/153; 348/159

(57) ABSTRACT

A security camera system capable of continuing controls and records even in an emergency wherein individual devices are broken.

A camera terminal transmits packets containing security graphic data to a security controller 100, and receives an acknowledge packet from the security controller 100. The camera terminal records a security image in a record medium packaged in the camera terminal, if it cannot receive the acknowledge packet, while assuming that the security controller has been broken or troubled.

### BACKGROUND OF THE INVENTION

1. Field of the Invention

The present invention relates to a security camera system.

2. Related Art

In the prior art, there is a security camera system for monitoring individual images by connecting a plurality of cameras. It is difficult to add a camera to the security controller, which has already been mounted on an office building or a house. This is because of necessity for wiring the new camera and the existing camera.

The prior art for solving this problem is disclosed in JP-A-2001-285844, for example. As shown in FIG. 9, this system is constructed to include a security controller 1 for controlling the entire security camera system and recording security images, and camera terminals 2 to 5 for photographing the security images. These devices are connected not through wires but wirelessly so that the wiring troubles are eliminated to enhance the degree of freedom for mounting the camera terminals.

### SUMMARY OF THE INVENTION

The security camera system has to continue the security operations even in an emergency where the devices constructing the system are individually broken. This is because the security camera system has to provide detailed images before and after the breakage when the devices are broken by a disaster or an invader.

However, the security camera system of the prior art is insufficient for resisting to such emergency. If a security controller for controlling the secure system is broken, for example, it is impossible to record not only the images photographed by the individual cameras but also the images of the emergency. Moreover, the individual cameras cannot be controlled to photograph the images in detail in the emergency or to communicate with an external security services firm using the external network. In case the network is formed into a loop, moreover, the inter-network communications cannot be performed, if one camera for relaying the data is troubled, to raise a problem that the security camera system is shut down.

In view of the aforementioned problems, the present invention has an object to provide a security camera system capable of continuing controls and records even in an emergency where the individual devices are broken.

In order to achieve the above-specified object, the present invention is constructed in the following manners.

(1) The security camera system comprises: a security controller for controlling the security camera system and recording an image; and at least one camera terminal having a camera for photographing the image, a transceiver unit for transmitting the photographed image wirelessly by disassembling it into packets or transmission units, and a record medium for recording the image photographed in an emergency. The camera terminal receives from the security controller at a predetermined interval an acknowledge packet indicating that the transmitted packet has been received by the security controller. The camera terminal judges it, if it cannot receive the acknowledge packet, that the controller has been broken or troubled, and records the photographed image in the record medium packaged therein.

(2) In the aforementioned construction (1), the record medium packaged in the camera terminal records the photographed image at all times, and rewrites the oldest one of the recorded video information in case the recording comes to the trailing end. When it is judged that the security controller has been broken, the overwrite of the images before and after the breakage is stopped.

(3) In the aforementioned construction (2), the camera terminal having detecting an abnormality after the security controller was broken photographs a suspicious object by using the record medium included in the camera terminal working in the ordinary state.

(4) In the aforementioned construction (1), the transceiver unit packaged in the camera terminal retrieves a security camera system in the neighborhood, when it is judged that the security controller has been broken, and informs the security services firm of the abnormality through a security controller discovered.

(5) In the aforementioned construction (1), when it is judged that the security controller has been broken, one of the camera terminals controls the security camera system in place of the security controller.

(6) In the aforementioned construction (1), each camera terminal is equipped with a discharger for driving itself when the power fails. Moreover, the camera terminal, the abnormality of which is not detected, is operated in a low power consumption mode by lowering its frame rate.

### BRIEF DESCRIPTION OF THE DRAWINGS

These and other features, objects and advantages of the present invention will become more apparent from the following description when taken in conjunction with the accompanying drawings, wherein:

FIG. 1 is a diagram showing a first embodiment of the invention;

FIG. 2 is a diagram showing a method for using a recording medium when an abnormality occurs, in a second embodiment of the invention;

FIG. 3 is a diagram showing a third embodiment of the invention;

FIGS. 4A and FIG. 4B are diagrams showing a fourth embodiment of the invention;

FIG. 5 is a diagram showing a fifth embodiment of the invention;

FIG. 6 is a diagram showing a construction of a camera terminal in the fifth embodiment of the invention;

FIG. 7 is a diagram showing a sixth embodiment of the invention;

FIG. 8 is a diagram showing a construction of a camera terminal in the sixth embodiment of the invention; and

FIG. 9 is a diagram showing the construction of a security camera system of the prior art.

### DETAILED DESCRIPTION OF THE PREFERRED EMBODIMENTS

The embodiments of the invention will be described with reference to the accompanying drawings.

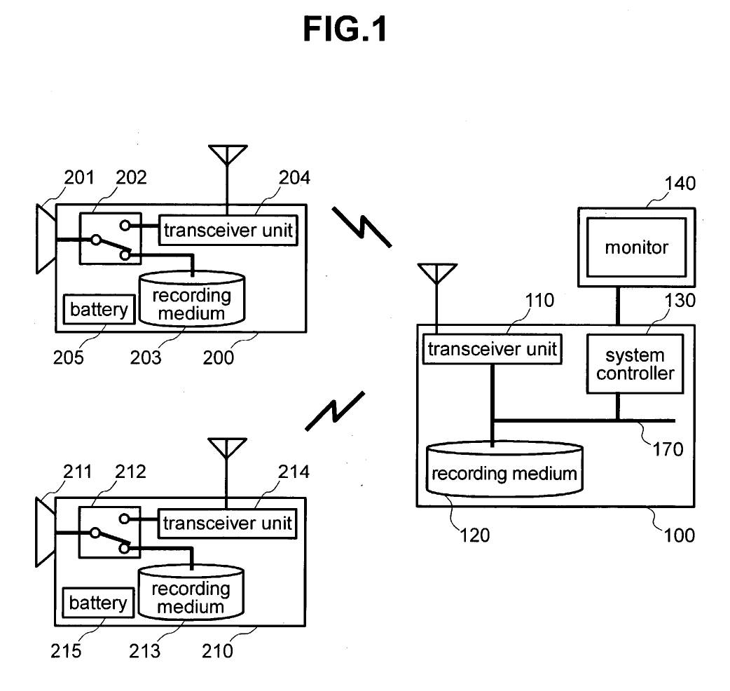

FIG. 1 is a diagram showing a first embodiment of a security camera of the invention. This security camera system comprises: a camera terminal 200 and a camera terminal 210 for photographing security images; and a security controller 100 for controlling the security camera system. The security controller 100 is constructed to include a transceiver unit 110, a record medium 120 and a system controller 130. The transceiver unit 110 transmits/receives the data with the later-described camera terminals and outputs them to a bus 170. The record medium 120 accepts the graphic data of the individual camera terminals, as received by the transceiver unit 110, from the bus 170, and records the accepted data. The system controller 130 controls the recording actions of the individual camera terminals, the write in the record medium and the display of the images photographed. A monitor 140 is connected with the security controller 100 to display the images photographed in the individual camera terminals.

The camera terminal 200 is constructed to include a camera 201, a switch 202, a recording medium 203, a transceiver unit 204 and a battery 205. The camera 201 converts the photographed image into electric signals, and outputs video signals. The switch 202 switches the output destination of the video signals of the image photographed by the camera 201. The recording medium 203 records the video signals of the image photographed by the camera 201. The transceiver unit 204 disassembles the video signals of the image photographed by the camera, into packets which are transmission units, and transmits them to the security controller 100. The battery 205 is ordinarily charged from an external power source, and acts as the power source for the camera terminal 200 when the power failure occurred so that the external power source is not available. The camera terminal 210 has such a construction like the camera terminal 200 and includes a camera 211, a switch 212, a recording medium 213, a transceiver unit 214 and a battery 215. These components are similar so that their descriptions will be omitted.

In FIG. 1, the transceiver unit 204 transmits a packet to the security controller 100 and then accepts an acknowledge packet indicating the reception of the packet, from the security controller 100. When the security controller 100 is broken, the transceiver unit 204 cannot receive the acknowledge packet so that the breakage of the security controller 100 can be detected. At this time, the output destination of the switch 202 of each camera terminal is switched from the transceiver unit 204 to the record medium 203 so that the photographed image is recorded in the record medium 203. Similar operations are done on the camera terminal 210. When the communication with the security controller is impossible, it is highly probable that an invader has been photographed in the security camera. Therefore, a detailed record may also be made by changing the frame rate or resolution of the photograph.

Even in case the security controller 100 was broken, according to the embodiment, the photographic data after breakage of the security controller are left in the record medium 203 so that the security image can be continuously photographed.

Here in FIG. 1, two sets of camera terminals are arranged for conveniences of description. However, the invention should not be limited to that arrangement but may also include one or more camera.

Moreover, the foregoing description is made assuming that each security controller receives the acknowledge packet each time it transmits the packet to the security controller. In order to reduce the communications, however, the construction may be modified to receive the acknowledge packet once for several packets.

When the power failed so that it is supplied with the battery 205, on the other hand, the camera 201 may lower the power consumption by lowering the frame rate.

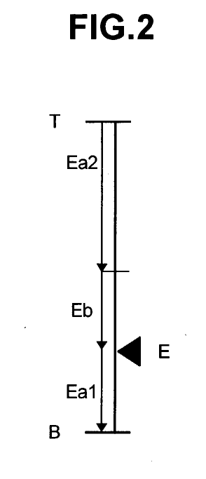

Next, a second embodiment of the invention will be described with reference to FIG. 1 showing the system construction of the security camera system and FIG. 2 showing the recording range of the record medium. FIG. 1 will not be described because it is common to the first embodiment.

In this embodiment, the switch 202 switches the output destinations in a time sharing manner so that the security image to be transmitted by the transceiver unit 204 and the security image to be recorded by the record medium 203 may always be identical to each other. The record medium 203 has a smaller capacity than that of the record medium 120 packaged in the security controller 100. When the security images are recorded to the trailing end of the record medium 203, therefore, the record medium 203 is returned to the leading end to overwrite the video signals at the earliest time in the record medium 120. These operations will be described with reference to FIG. 2. FIG. 2 shows the capacity of the record medium 203, which is assumed to be able to record from point T to point B. The record of a security image is started from point T and is sequentially continued to point B. When the record is made to point B, the write is returned to point T so that the record is started again to point B.

Here will be described the operations at the time when the acknowledge packet cannot be received and when the controller breakage is detected. It is assumed that the controller breakage is detected at the instant when the record has been made to point E in FIG. 2. Then, the camera terminal quits the write in the record medium at the instant when a period Ea1 and a period Ea2 were recorded. Therefore, the record medium is stored with a period Eb before detection of the controller breakage and the period Ea1 and the period Ea2 after the detection. For the period Eb, the security controller sets the individual camera terminals at the ordinary operation time.

According to the second embodiment of the invention thus far described, the security image is recorded in both the camera terminals and the security controller so that the data are duplicated. Even in case the security controller is broken, therefore, the images before and after occurrence of the breakage can be acquired from the individual camera terminals. If one of the camera terminals is photographed at an angle covering the security controller, it is possible to photograph the history of the security controller being broken.

In this embodiment, moreover, the camera terminal, the abnormality of which is detected after the breakage of the security controller was detected, may be enabled to use the record medium which is packaged in another camera terminal. If an abnormality is detected in the camera terminal 200 after the security controller was broken, as shown in FIG. 1, the transceiver unit 204 transmits the security image to the camera terminal 210, the abnormality of which is not detected yet. The transceiver unit 214 in the camera terminal 210 receives the security image transmitted by the camera terminal 210, and records it in the record medium 213. By making the aforementioned controls, the image before occurrence of the abnormality is recorded in the record medium 203, and the image after detection of the abnormality, as photographed by the camera 201, is recorded in the record medium 213. Therefore, the camera terminal 200 can use the record medium of a capacity twice as large as the held one so that the image after breakage of the security controller can be recorded for a long time.

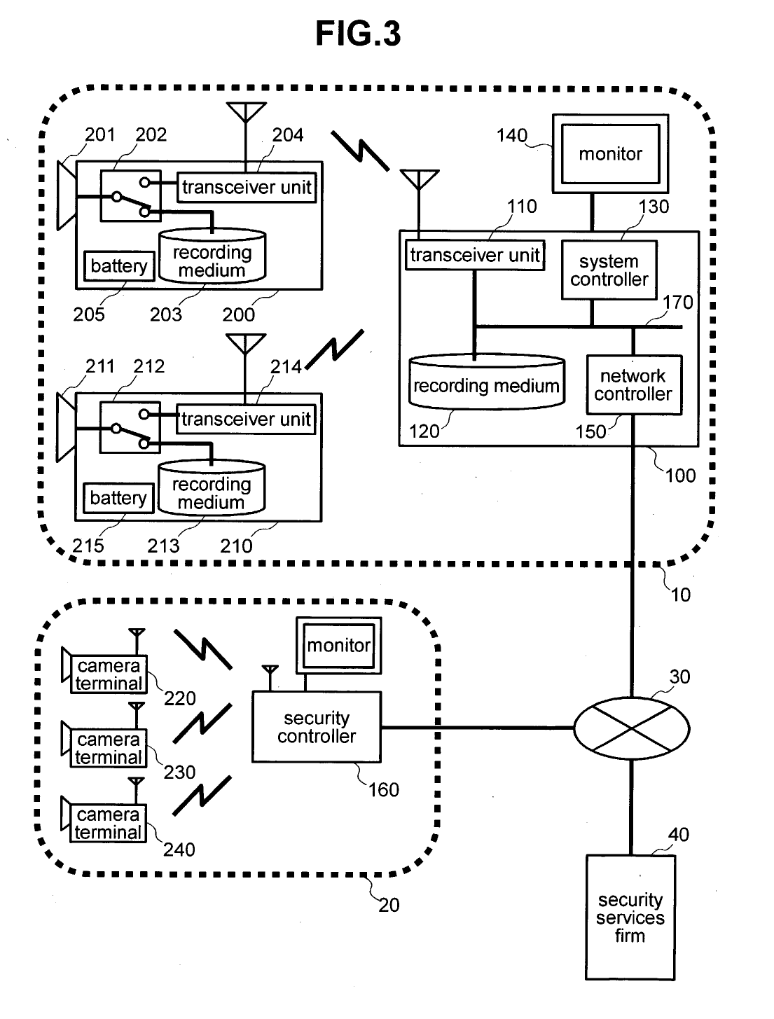

A third embodiment of the invention will be described with reference to FIG. 3. FIG. 3 shows a connection of the security camera system with a security services firm. In FIG. 3, the description of the same portions as those of the security camera system shown in FIG. 1 will be omitted by designating the portions by the common reference numerals. A network controller 150, as packaged in the security controller 100, makes a line control to call a security services firm 40 via an external network 30 when an abnormality occurs. A security camera system 10 is constructed to include a camera terminal 200, a camera terminal 210, a security controller 100 and a monitor 140. A security camera system 20 will not be described because it has a construction similar to that of the security camera system 10.

When it is detected that the security controller 100 has been broken, as shown in FIG. 3, a transceiver unit 204 packaged in the camera terminal 200 retrieves a security camera system existing in the neighborhood. If a neighborhood security controller 160 is discovered, the transceiver unit 204 informs the abnormal information to the security services firm through the security controller 160. In case the camera terminal 200 detects an abnormality after breakage of the security controller, on the other hand, the security image may be transmitted through the security controller 160.

Even if the security controller 100 is broken, according to the third embodiment of the invention thus far described, it is possible to inform the camera abnormality through the security camera system in the neighborhood. By the cooperation of the security camera systems, the breakage of individual units, if any, hardly affects the operations of the security camera systems. This embodiment is effective especially in case the individual homes of an apartment house are provided with the small-scale security camera systems.

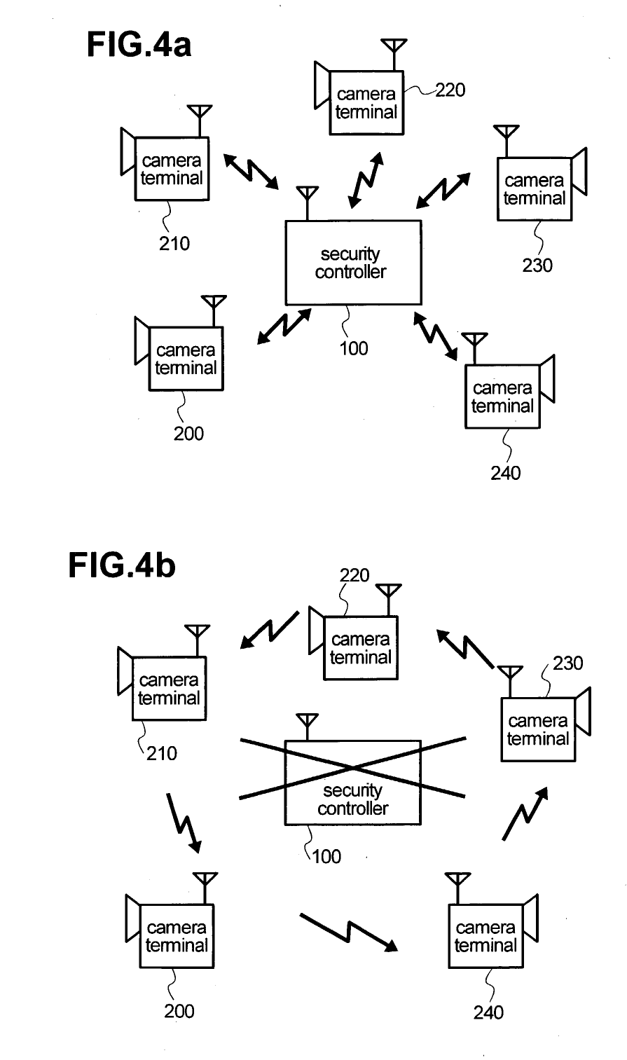

A fourth embodiment of the invention will be described with reference to FIG. 4A and FIG. 4B. FIG. 4A and FIG. 4B are diagrams showing a construction of the security camera system. FIG. 4A shows the behaviors in which the camera terminals communicate at an ordinary time, and FIG. 4B shows the behaviors in which the camera terminals communicate when the security controller is broken. In FIG. 4A and FIG. 4B, the description of the same portions as those of the security camera system shown in FIG. 1 will be omitted by designating them by the common reference numerals. Moreover, camera terminals 220 to 240 have constructions similar to that of the camera terminal 200 shown in FIG. 1.

As shown in FIG. 4A, the individual camera terminals communicate one-by-one with the security controller 100 at an ordinary operation time. When the security controller is broken, the individual camera terminals construct a loop network sequentially in a predetermined order to communicate on the camera information periodically. Here, the camera information indicates the connecting order of the individual cameras and the abnormality information on a suspicious object detected. In FIG. 4B, the camera terminal 200 receives the information on other cameras from the camera terminal 210, and updates the camera information of the camera terminal 200 and transmits it to the camera terminal 240. From now on, the camera information is transmitted to the camera terminal 240, the camera terminal 230, the camera terminal 220 and the camera terminal 210 and again to the camera terminal 200.

When each camera terminal cannot receive from another camera terminal with which it is communicating, it reconstructs the loop network, deciding that the latter camera terminal has been broken or troubled. It is assumed in FIG. 4B that the camera terminal 200 is broken subsequent to the security controller 100, for example. Then, the camera terminal 240 receiving the camera information from the camera terminal 200 cannot receive the camera information. Therefore, the camera terminal 240 changes the connection order of the camera, so that the loop network is reconstructed by changing the connection information to cause the camera terminal 210 to transmit the information to the camera terminal 240, and to transmit the camera information to the camera terminal 230.

According to the fourth embodiment of the invention thus far described, the operations of the security camera system can be continued even when the security controller is broken. Moreover, the camera terminals manage the connection information dynamically so that the operations of the security camera system can be continued even if the individual camera terminals are broken.

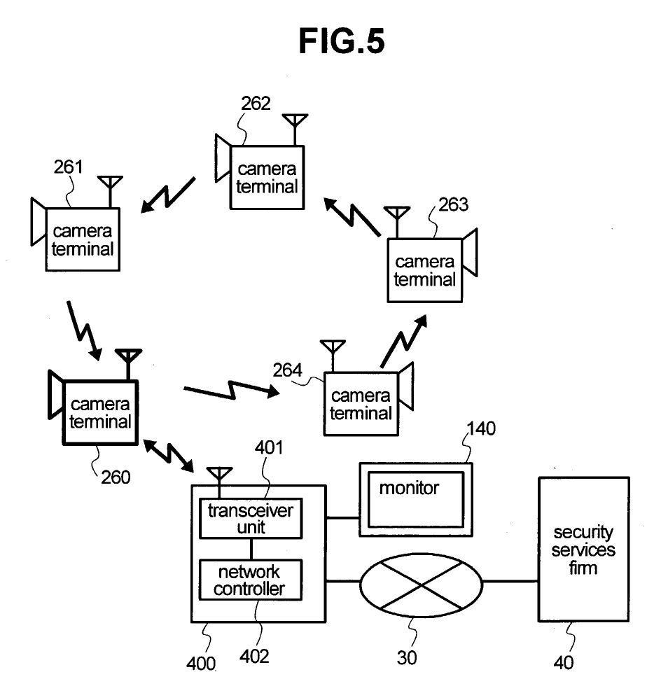

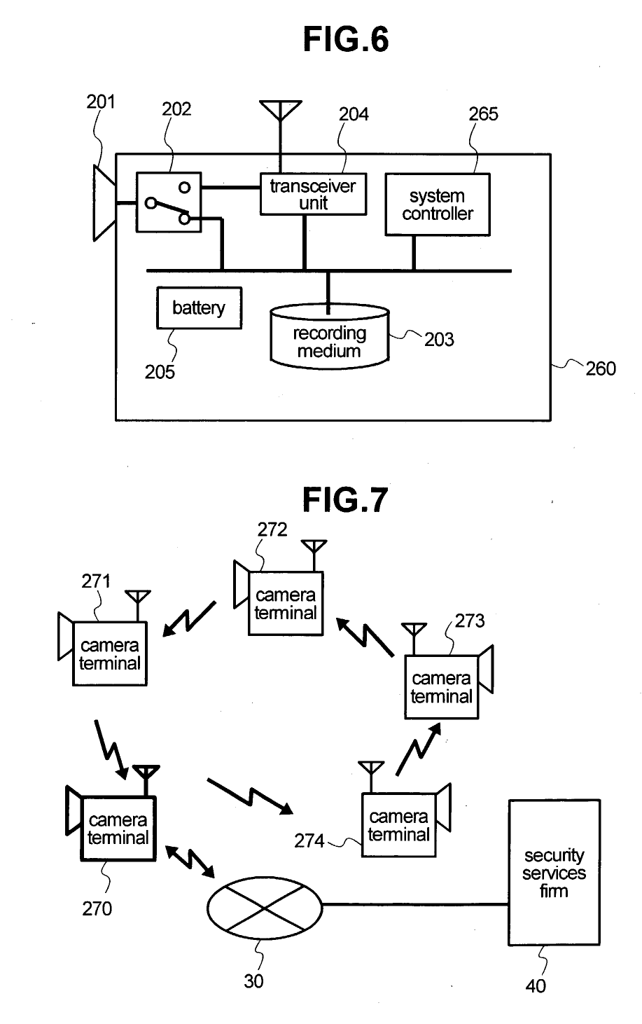

A fifth embodiment of the invention will be described with reference to FIG. 5 showing a construction of a security camera system and FIG. 6 showing an internal construction of a camera terminal. FIG. 5 shows the construction of the security camera system, of which the same portions as those of FIG. 1 will not be described by designating them by the common reference numerals. A network terminal 400 accepts the abnormality information from a camera terminal and calls the security services firm 40 through the external network 30. The network terminal 400 is constructed to include the transceiver unit 110 and the network controller 150, which are identical to those included by the security controller 100 of FIG. 3 so that their description will be omitted.

Camera terminals 260 to 264 have a block construction shown in FIG. 6. Next, the construction of the camera terminal 260 in the fifth embodiment will be described with reference to FIG. 6. In the camera terminal 260, the description of the same portions as those of the camera terminal 200 shown in FIG. 1 will be omitted by designating them by the common reference numerals.

A system controller 265 controls the security camera system such that the system controller 265 of preset one of all the camera terminals of the security camera system controls the security camera system. Moreover, the system controller 265 communicates with the network terminal 400 and calls the security services firm 40 when an abnormality occurs. The individual camera terminals transmit the camera information such as the connection information and the abnormality detecting state to the camera terminals of a preset order. In the embodiment shown in FIG. 5, the camera information is transmitted to the camera terminal 260, the camera terminal 264, the camera terminal 263, the camera terminal 262 and the camera terminal 261 sequentially in the recited order. Like the fourth embodiment, moreover, when the camera information cannot be received, the loop network is reconstructed assuming that the corresponding camera terminal has been broken.

According to this embodiment thus far described, one of the camera terminals controls the security camera system so that the security controller need not be included. In case one camera terminal is broken, moreover, another camera terminal in the security camera system acts as the security controller to control the security camera system so that the resistance of the entire system to the breakage of each camera is improved.

In the foregoing description, moreover, the control of the security camera system is switched when a camera terminal is broken, but the camera terminal for making the control may be switched for every preset time intervals. Each camera terminal may communicate with the network terminal 400, when its turn comes to the control of the security camera system, and may inform the security services firm of the prevailing situations. By switching the controlling camera terminals suitably, the data to be transmitted to the security services firm do not flow on the loop network so that more camera information can be transmitted.

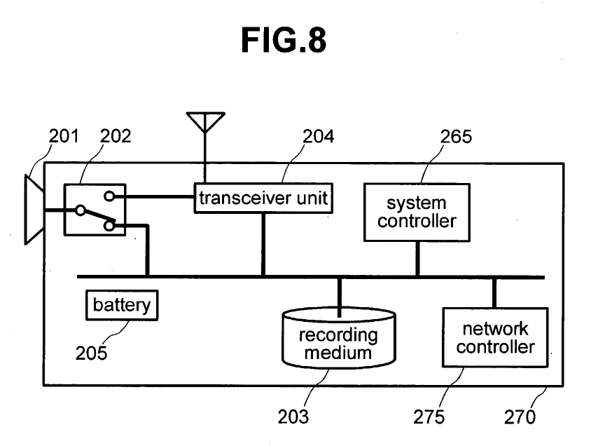

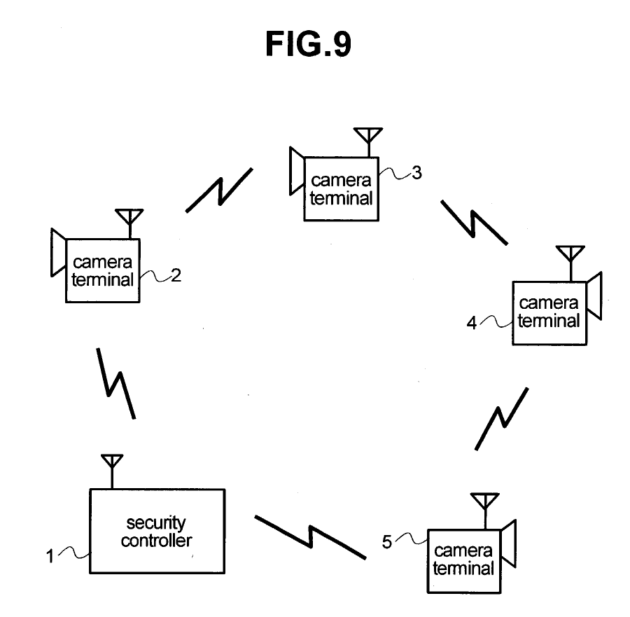

Next, a sixth embodiment of the invention will be described with reference to FIG. 7 showing a construction of a security camera system and FIG. 8 showing an internal construction of a camera terminal. FIG. 7 shows the construction of the security camera system, of which the same portions as those of FIG. 5 will not be described by designating them by the common reference numerals.

Camera terminals 270 to 274 have a block construction shown in FIG. 8, and one of the camera terminals constructing the security camera system communicates with the external network 30. Next, the construction of the camera terminal 270 in the sixth embodiment will be described with reference to FIG. 8. In the camera terminal 270, the same portions as those of FIG. 5will not be described by designating them by the common reference numerals. A network controller 275 makes the line control, when the system controller 265 controls the security camera system, to connect it with the external network. When a camera terminal constructing the security camera system detects a suspicious object, moreover, it calls the security services firm 40 through the external network 30.

According to this embodiment thus far described, one of the camera terminals makes the line control to call the security services firm so that the network terminal included by the fifth embodiment can be dispensed with. Moreover, the communications with the external network 30 are made wireless so that no shutdown from the external network is caused by a line disconnection.

According to the invention, the operations of the security camera system can be continued even in case the individual components of the system are broken or troubled by an invader. Moreover, the trouble of the device can be informed to the security services firm located outside of the system.

While we have shown and described several embodiments in accordance with our invention, it should be understood that the disclosed embodiments are susceptible of changes and modifications without departing from the scope of the invention. Therefore, we do not intend to be bound by the details shown and described here but intend to cover all such changes and modifications as fall within the ambit of the appended claims.

We claim:

1. A security camera system comprising:
a camera terminal having a camera unit for photographing an image and outputting video signals, a first transceiver unit for outputting the video signals outputted by said camera unit, wirelessly to a security controller, and a first record medium capable of recording the video signals outputted by said camera unit; and
a security controller having a second transceiver unit for receiving the video signals outputted by said first transceiver unit, a second record medium for recording the video signals received by said second transceiver unit, and a system controller for controlling the record setting of said camera terminal and the write in said second record medium,
wherein said camera terminal does not write in said first record medium at an ordinary state but records the photographed video signals in said first record medium when it is detected that said security controller cannot be used.

2. A security camera system according to claim 1,
wherein said first record medium packaged in said camera terminal records the image photographed by said camera unit, even at the ordinary time, and overwrites and record the oldest image in said first record medium when it is recorded to the trailing end, and
wherein the image recorded in said first record medium is not overwritten when it is detected that said security controller cannot be used.

3. A security camera system according to claim 1,
wherein said camera terminal records a suspicious object in said first record medium when said suspicious object is photographed after it is detected that said security controller could not be used.

4. A security camera system according to claim 1,
wherein said security controller has a network controller for making a line control and calling a security services firm located outside of the security camera system, when said camera terminal detects a suspicious object, and
wherein said camera terminal retrieves another security camera system located in the neighborhood, when it is detected that said security controller cannot be used, to call the security services firm by making use of said security controller for controlling another security camera system.

5. A security camera system according to claim 1,
wherein said camera terminal is provided in plurality, and
wherein said camera terminals form a loop network, in which said camera terminal transmits, when it is detected that said security controller cannot be used, the suspicious object detection information of the camera and the camera information on the connection order of said camera terminals in a predetermined order to another camera terminal, and reconstructs the network by changing the connection order, when said camera information cannot be received, while assuming that said camera terminal is broken or troubled.

6. A security camera system comprising:
a security controller;
a plurality of camera terminals each having a camera unit for photographing an image and outputting video signals, a first transceiver unit for outputting the video signals outputted by said camera unit, wirelessly to a security controller, a record medium capable of recording the video signals outputted by said camera unit, and a system controller for making controls to set the individual records of said camera terminals when the control turn comes in a security camera network; and
a network terminal having a second transceiver unit for receiving the abnormality information having detecting a suspicious object, from said camera terminal controlling said security camera system, and a network controller for calling a security services firm located outside of the security camera system,
wherein one of a predetermined order of said camera terminals controls the security camera system when it is detected that said camera terminal for controlling the security camera system cannot be used.

7. A security camera system comprising: a first camera terminal having a first camera unit for photographing an image and outputting video signals; and a second camera terminal having a second camera unit for photographing an image and outputting video signals,
said first camera terminal having a first record medium capable of recording the video signals outputted by said first camera unit, a first transceiver unit capable of outputting the video signals outputted by said first camera unit and said second camera unit, wirelessly to a security controller, and a first system controller capable of controlling the records of the video signals in said first camera terminal and said second camera terminal,
said second camera terminal having a second record medium capable of recording the video signals outputted by said second camera unit, a second transceiver unit capable of outputting the video signals outputted by said first camera unit and said second camera unit, wirelessly to said security controller, and a second system controller capable of controlling the records of the video signals in said first camera terminal and said second camera terminal,
further comprising: switching means for switching either of said first transceiver unit and said second transceiver unit to output the video signals outputted by said first camera unit and said second camera unit, wirelessly to said security controller,
wherein when said first transceiver unit is switched to output the video signals to said security controller, said second transceiver unit is switched to output the video signals if it is detected that an abnormality occurs in said first camera terminal.

8. A recording method for recording a security image in a security system having a camera terminal and a security controller,
wherein said camera terminal transmits packets containing security graphic data to said security controller, and records, if it cannot receive an acknowledge packet from said security controller, said security graphic data in a record medium packaged in said camera terminal.
